(19) United States
(12) Patent Application Publication
(10) Pub. No.: US 2012/0174304 A1
(43) Pub. Date: Jul. 12, 2012

(54) Toilet Bowl Cleaning Device Including Container Retention Mechanism

(76) Inventors: Matthew Abbondanzio, Milwaukee, WI (US); Ronald J. Schmidt, Grayslake, IL (US); Barry Thrune, New Berlin, WI (US); James R. Crapser, Racine, WI (US); Thomas A. Helf, New Berlin, WI (US); Sandy K. Foley, Franklin, WI (US); Jeffrey L. Crull, McFarland, WI (US); Jonathon Daniel Toback, Chicago, IL (US); Martin Rathgeber, Chicago, IL (US); Jon M. Hursey, Saint Charles, IL (US); Evan A. Sparks, Madison, WI (US)

(21) Appl. No.: 13/291,352

(22) Filed: Nov. 8, 2011

Related U.S. Application Data
(60) Provisional application No. 61/411,841, filed on Nov. 9, 2010.
(60) Provisional application No. 61/513,466, filed on Jul. 29, 2011.

(51) Int. Cl. E03D 9/02; B67D 7/84

(52) U.S. Cl. 4/223; 222/173

(57) ABSTRACT

A device for spraying an inner surface of an enclosure with a cleaning and/or deodorizing chemical is disclosed. The device can include a container for the chemical, a container holder, a sprayer through which the chemical can be sprayed laterally at least halfway around a perimeter of the sprayer, a clip attaching the sprayer near a rim of the toilet bowl, a fluid conduit in fluid communication with the container and the sprayer, and a retention mechanism retaining the container in the container holder. One form of the retention mechanism includes a retainer having a plurality of flexing tabs that engage a flange on the holder. In another form, the retention mechanism can include inwardly directed flanges on an inner wall of the holder, a projection spaced apart from each flange, and a retainer with a plurality of fins. A refill for a dispensing system is also disclosed.

### CROSS-REFERENCES TO RELATED APPLICATIONS

This application claims priority from U.S. Patent Application No. 61/411,841 filed Nov. 9, 2010 and U.S. Patent Application No. 61/513,466 filed Jul. 29, 2011.

### STATEMENT REGARDING FEDERALLY SPONSORED RESEARCH

Not Applicable.

### BACKGROUND OF THE INVENTION

1. Field of the Invention

This invention relates to a toilet bowl cleaning device where the inner surface of the toilet bowl can be cleaned around the entire circumference of the toilet bowl at locations below the toilet waterline, and/or locations at the toilet waterline, and/or locations above the toilet waterline, and/or locations under the toilet rim. The toilet bowl cleaning device includes a lock and key retention mechanism for retaining a container in a container holder of the device, and a foot actuated lever for releasing a fluid from the container into a fluid delivery system.

2. Description of the Related Art

Toilet bowls require care to prevent the buildup of unsightly deposits, to reduce odors, and to prevent bacteria growth. Traditionally, toilet bowls have been cleaned, deodorized, and disinfected by manual scrubbing with a liquid or powdered cleaning and sanitizing agent. This task has required manual labor to keep the toilet bowl clean.

In order to eliminate the detested manual scrubbing, various toilet bowl cleaner dispensers have been proposed. One type of dispenser comprises a solid block or solid particles of a cleansing and freshening substance that is suspended from the rim of a toilet bowl in a container that is placed in the path of the flushing water. U.S. Pat. No. 4,777,670 (which is incorporated herein by reference along with all other documents cited herein) shows an example of this type of toilet bowl cleaning system. Typically, a portion of the solid block is dissolved in the flush water with each flush, and the flush water having dissolved product is dispensed into the toilet bowl for cleaning the bowl.

Other toilet bowl cleaning systems use a liquid cleaning agent that is dispensed into a toilet bowl. For example, U.S. Pat. Nos. 6,178,564 and 6,230,334, and PCT International Publication Nos. WO 99/66139 and WO 99/66140 all disclose cleansing and/or freshening devices capable of being suspended from the rim of a toilet bowl for introducing liquid active substances from a bottle into the flushing water with each flush. In these under the toilet rim devices, the liquid active substances are delivered downward from a reservoir to a dispensing plate that is supported by a base that is suspended from the toilet bowl rim. The device is suspended from the toilet rim such that the flow of flush water from the toilet contacts the dispensing plate during a flush. The flush water carries the liquid active substances that are on the dispensing plate into the toilet bowl to clean and freshen the toilet.

Other toilet bowl dispensers use an aerosol deodorizing and/or cleaning agent that is dispensed into a toilet bowl through a conduit attached to the toilet bowl rim. For example, U.S. Pat. No. 3,178,070 discloses an aerosol container mounted by a bracket on a toilet rim with a tube extending over the rim; and U.S. Pat. Nos. 6,029,286 and 5,862,532 disclose dispensers for a toilet bowl including a pressurized reservoir of fluid, a conduit connected to the source of fluid, and a spray nozzle which is installed on the toilet rim.

One disadvantage with these known toilet rim dispensing devices is that these devices may only apply the deodorizing and/or cleaning agent to one location in the toilet water or a limited area in the toilet water or on the inner surface of the toilet bowl. As a result, the cleaning of the inner surface of the toilet bowl may be limited to an area of the toilet bowl near the device. This is a drawback as it is desirable to obtain uniform application of cleaning fluid in the entire toilet bowl.

U.S. Pat. No. 7,603,726 sets forth, among others, an automatic or manual toilet bowl cleaning device where the inner surface of the toilet bowl is cleaned around the entire circumference of the toilet bowl. In one embodiment illustrated in that application, the downstream end of a fluid conduit terminates in a rotating nozzle capable of spraying the fluid outwardly onto the inner surface of the toilet bowl.

In view of the advance in the art provided by the device of U.S. Pat. No. 7,603,726, even further improvements to this technology would be beneficial to consumers.

### SUMMARY OF THE INVENTION

The foregoing needs can be met with a toilet bowl cleaning and/or deodorizing device according to the invention that delivers a chemical into the toilet bowl. The term “chemical” or “chemistry” means one chemical or a mixture of chemical ingredients. Various cleaning and/or deodorizing chemicals are suitable for use with a toilet bowl cleaning device according to the invention. The toilet bowl cleaning and/or deodorizing device includes appropriate chemistry and a dispensing system. As used herein, the term “cleaning” also includes sanitizing and/or disinfecting, and the term “deodorizing” also includes freshening.

Regarding the chemistry, a chemical is applied directly onto the inner surface of the toilet bowl and/or into the toilet water so as to clean and freshen the toilet bowl. If applied to the inner surface of the toilet bowl, the chemical will typically be a liquid (single or multiple chemistries). If added to the toilet water, the chemistry can also be a liquid (single or multiple chemistries) that is added to the water to act as a preventive, or to create an environment that will work to clean the toilet automatically.

With respect to the dispensing system, the system includes several subsystems which are the means for applying the appropriate chemistry to the inner surface of the toilet bowl to conduct the cleaning process. The dispensing system may include (but is not limited to): (i) a chemistry storage container; (ii) a chemical propulsion system; (iii) a chemical delivery system; and (iv) a toilet interface.

The chemistry storage container is used to hold and store the chemistry used to clean the toilet bowl. Non-limiting examples include a standard plastic bottle, such as that found on a trigger sprayer.

The chemical propulsion system provides a method of providing the appropriate energy to the chemistry to move it through the delivery system so that it can move from the storage container to the appropriate area within the toilet bowl. Examples of this subsystem include a pump or pumping mechanism to move a liquid such as a vein pump, bellows pump, impeller driven pump, piston pump, peristaltic pump or gear driven pump.

The chemical delivery system provides a method of moving chemistry from its storage container to the appropriate area within the toilet bowl. This delivery subsystem can include a hose and a sprayer (e.g., a nozzle).

The toilet interface provides a means and method of attachment to the toilet to keep the hose out of the way, keep it uncrimped, and secure the sprayer nozzle into place on the toilet rim or toilet lid.

These subsystems work together to deliver the appropriate chemistry (using predetermined amounts) to deliver the desired consumer benefit.

Therefore, in one aspect, the invention provides a device for spraying an inner surface of a wall of an enclosure with a fluid. The device includes: a container for the fluid; a container holder; a fluid conduit in fluid communication with the container and a fluid sprayer; means for attaching the fluid sprayer near the inner surface of the wall of the enclosure; and a retention mechanism for retaining the container in the container holder wherein the retention mechanism is connected to the container adjacent an end of the container.

In one form of the device, the retention mechanism includes a flange on a wall of the holder wherein the wall defines the opening of the holder. The retention mechanism further includes a retainer dimensioned to engage the container wherein the retainer has a flexing tab in a side wall of the retainer. The flexing tab is dimensioned to releasably engage the flange of the holder.

In one form of the retention mechanism, the flange of the holder is inwardly directed on the wall of the holder.

In another form of the retention mechanism, a bottom wall of the retainer includes at least one slot that engages a locating tab on the holder.

In another form of the retention mechanism, there is an inwardly directed flange on a wall of the holder wherein the wall defines the opening of the holder, and the retainer is dimensioned to engage the container. The retainer has a plurality of flexing tabs in a side wall of the retainer, and the flexing tabs are dimensioned to releasably engage the inwardly directed flange of the holder.

In another form of the retention mechanism, there is an inwardly directed flange on a wall of the holder wherein the wall defines the opening of the holder, and the retainer is dimensioned to engage the container. The retainer has a pair of flexing tabs in a side wall of the retainer, and the flexing tabs are dimensioned to releasably engage the inwardly directed flange of the holder wherein the flexing tabs are on opposite ends of a diameter of the retainer.

In another form of the device, the retention mechanism includes a plurality of inwardly directed flanges on an inner wall of the holder, the inner wall defining the opening of the holder; a stop connected to each flange, each stop extending laterally from its associated flange; a projection spaced apart from each flange and adjacent to the stop associated with each flange, each projection connected to the inner wall of the holder and being inwardly directed from the inner wall of the holder; and a retainer dimensioned to engage the container, the retainer having a plurality of fins extending outward from a central region of the retainer, each fin being dimensioned to pass between adjacent projections when the retainer is moved toward the flanges, each fin being dimensioned to enter a space adjacent one of the projections and contact one of stops when the container is rotated after the fins have passed the projections.

In another form of the device, the container is an aerosol can having a pedestal surrounding a valve stem. Further the retainer includes a central annular wall dimensioned to engage the pedestal.

In another form of the device, the central annular wall is dimensioned to engage a groove in the pedestal.

In another form of the device, the container is an aerosol can having a valve stem. Further, the device includes a triggering apparatus for moving the valve stem to an open position in which the fluid exits the container, travels through the fluid conduit, moves through the fluid sprayer and is sprayed on the wall of the enclosure.

In another form of the device, the triggering apparatus comprises a foot actuated lever linked to the valve stem.

In another form of the device, the triggering apparatus comprises a foot actuated lever linked to a fluid manifold that moves the valve stem.

In another form of the device, the manifold has an inlet port that moves the valve stem, and an outlet port in fluid communication with the fluid conduit.

In another form of the device, the holder receives the container in an inverted position of the container. Further the retention mechanism prevents movement of the container when the foot actuated lever is pressed.

In another form of the device, the enclosure is a toilet bowl.

The present invention also provides a device for spraying an inner surface of a wall of an enclosure with a fluid. The device includes a container for the fluid wherein the container is an aerosol can having a valve stem; a container holder for receiving the container; a fluid conduit in fluid communication with the container and a fluid sprayer; means for attaching the fluid sprayer near the inner surface of the wall of the enclosure; and a triggering apparatus comprising a foot actuated lever linked to a fluid manifold for moving the valve stem to an open position in which the fluid exits the container, travels through the fluid manifold, travels through the fluid conduit, moves through the fluid sprayer and is sprayed on the wall of the enclosure.

In one form of the device, the manifold has an inlet port that moves the valve stem, and an outlet port in fluid communication with the fluid conduit.

In another form of the device, the device includes a retention mechanism for retaining the container in the container holder, and the holder receives the container in an inverted position of the container, and the retention mechanism prevents movement of the container when the foot actuated lever is pressed.

In another form of the device, the enclosure is a toilet bowl.

The present invention also provides a retention mechanism for a dispenser including a container and a holder for receiving the container in an opening of the holder.

In one form, the retention mechanism includes a flange on a wall of the holder, and a retainer dimensioned to engage the container wherein the retainer has a flexing tab in a side wall of the retainer, and the flexing tab is dimensioned to releasably engage the flange of the holder.

In another form of the retention mechanism, the flange of the holder is inwardly directed on the wall of the holder.

In another form of the retention mechanism, the bottom wall of the retainer includes at least one slot that engages a locating tab on the holder.

In another form of the retention mechanism, the retainer has a plurality of flexing tabs in a side wall of the retainer, and the flexing tabs are dimensioned to releasably engage the inwardly directed flange of the holder.

In another form of the retention mechanism, the retainer has a pair of flexing tabs in a side wall of the retainer, and the flexing tabs are dimensioned to releasably engage the inwardly directed flange of the holder, and the flexing tabs are on opposite ends of a diameter of the retainer.

In another aspect, the retention mechanism includes: a plurality of inwardly directed flanges on an inner wall of the holder, the inner wall defining the opening of the holder; a stop connected to each flange, each stop extending laterally from its associated flange; a projection spaced apart from each flange and adjacent to the stop associated with each flange, each projection connected to the inner wall of the holder and being inwardly directed from the inner wall of the holder; and a retainer dimensioned to engage the container, the retainer having a plurality of fins extending outward from a central region of the retainer, each fin being dimensioned to pass between adjacent projections when the retainer is moved toward the flanges, each fin being dimensioned to enter a space adjacent one of the projections and contact one of the stops when the container is rotated after the fins have passed the projections.

In one form of the retention mechanism, the container is an aerosol can having a pedestal surrounding a valve stem. Further, the retainer includes a central annular wall dimensioned to engage the pedestal.

In another form of the retention mechanism, the central annular wall is dimensioned to engage a groove in the pedestal.

In another form of the retention mechanism, each projection is connected to the adjacent stop associated with each flange.

In another form of the retention mechanism, the flanges are positioned on the inner wall of the holder in generally the same plane.

In another form of the retention mechanism, the projections are equally spaced around the inner wall of the holder.

In another form of the retention mechanism, the mechanism includes an equal number of projections and fins and stops.

In another form of the retention mechanism, the number of projections and fins and stops is four.

In another form of the retention mechanism, the holder includes a bottom wall structured to rest on a horizontal surface such that the opening of the holder faces upward. Further, the holder receives the container in an inverted position of the container.

The present invention provides a refill for a sprayer system including a container holder and a fluid conduit in fluid communication with an outlet of the container holder and a fluid sprayer.

In one aspect, the refill includes a container, and a retainer connected to the container. The retainer has a flexing tab in a side wall of the retainer, and the flexing tab is dimensioned to releasably engage a flange of the container holder.

In one form of the refill, the flange of the container holder is inwardly directed on a wall of the container holder.

In another form of the refill, a bottom wall of the retainer includes at least one slot that engages a locating tab on the container holder.

In another form of the refill, the flange of the container holder is inwardly directed on a wall of the container holder, and the retainer has a plurality of flexing tabs in a side wall of the retainer wherein the flexing tabs are dimensioned to releasably engage the inwardly directed flange of the container holder.

In another form of the refill, the flange of the container holder is inwardly directed on a wall of the container holder, and the retainer has a pair of flexing tabs in a side wall of the retainer. The flexing tabs are dimensioned to releasably engage the inwardly directed flange of the container holder, and the flexing tabs are on opposite ends of a diameter of the retainer.

In another form of the refill, the flexing tab has an outwardly directed projection dimensioned to engage the flange of the container holder.

In another form of the refill, the projection on the flexing tab includes a ramped outer surface.

In another aspect, the refill includes: a container; and a retainer. The retainer is connected to the container. Further, the retainer has a plurality of fins extending outward from a central region of the retainer. Each fin is dimensioned to engage a flange on an inner wall of the container holder. Further, each fin is dimensioned to pass between adjacent projections connected to the inner wall of the container holder when the retainer is moved into an opening of the container holder. Further, each fin is dimensioned to enter a space adjacent one of the projections and contact a stop of the container holder when the container is rotated after the fins have passed the projections and have engaged one of the flanges.

In one form of the refill, the container is an aerosol can having a pedestal surrounding a valve stem. Further, the retainer includes a central annular wall dimensioned to engage the pedestal.

In another form of the refill, the central annular wall is dimensioned to engage a groove in the pedestal.

In another form of the refill, a portion of the retainer engages a dome of the aerosol can.

In another form of the refill, the fins are equally spaced around the retainer.

In another form of the refill, the number of fins is four.

In another aspect, the invention provides a device for spraying an inner surface of a wall of an enclosure with a fluid. The device includes a container for the fluid, a container holder, a fluid conduit in fluid communication with the container and a fluid sprayer, a clip attaching the fluid sprayer near the inner surface of the wall of the enclosure, and a retention mechanism retaining the container in the container holder. The retention mechanism includes a retainer connected to the container adjacent an end of the container.

In one form of the device, the retention mechanism further includes at least one inwardly directed flange on a wall of the holder, the wall defining the opening of the holder. The retainer is dimensioned to engage the container and has a plurality of flexing tabs. The flange is a circumferential flange and the plurality of flexing tabs engage the circumferential flange. The plurality of flexing tabs can include a pair of flexing tabs that are on opposite ends of a diameter of the retainer, each of the pair of flexing tabs having an outwardly directed projection with a ramped outer surface. The outwardly directed projections are dimensioned to releasably engage the circumferential flange.

In another form of the device, the retention mechanism further includes a plurality of flanges on an inner wall of the holder, a stop connected to each flange, each stop extending laterally from its associated flange, and a projection spaced apart from each flange and adjacent to the stop associated with teach flange. Each projection is connected to the inner wall of the holder and is inwardly directed from the inner wall of the holder. The retainer is dimensioned to engage the container and has a plurality of fins extending outward from a central region of the retainer. Each fin is dimensioned to pass between adjacent projections when the retainer is moved toward the flanges. Each fin is dimensioned to enter a space adjacent one of the projections and contact one of the stops when the container is rotated after the fins have passed the projections.

In another aspect, the invention provides for a retention mechanism for a dispenser including a container and a holder for receiving the container in an opening of the holder. The retention mechanism includes at least one flange on a wall of the holder and a retainer dimensioned to engage the container. The retainer is connected to the container adjacent an end of the container.

In yet another aspect, the invention provides for a refill for a sprayer system including a container holder and a fluid conduit in fluid communication with an outlet of the container holder and a fluid sprayer. The refill includes a container and a retainer connected to the container. The retainer has at least one flexing tab in a side wall of the retainer.

In one form of the refill, the retainer has a pair of flexing tabs in the sidewall of the retainer on opposite ends of a diameter of the retainer. The pair of flexing tabs each have an outwardly directed projection with a ramped outer surface. The pair of flexing tabs are dimensioned to releasably engage a circumferential flange of the container holder. The ramped outer surface of each projection is configured to inwardly flex the flexing tabs when the container is pushed into the container holder until the projections move under a flange of the container.

It is therefore an advantage of the invention to provide a toilet bowl cleaning device where the inner surface of the toilet bowl is cleaned around the entire circumference of the toilet bowl. The device provides for overall toilet bowl cleanliness by enhanced shine and the retardation of biofilm, mold and/or mildew growth. The device can deliver liquids to remove or eliminate stains (hard water, limescale, metals, organic), mold, mildew, germs, odors, and bacteria. The device can spray the entire toilet bowl and is not limited to just one small area of the toilet bowl.

These and other features, aspects, and advantages of the present invention will become better understood upon consideration of the following detailed description and drawings.

### BRIEF DESCRIPTION OF THE DRAWINGS

FIG. 1A is a perspective view of a prior art toilet bowl cleaning assembly.

FIG. 1B is an enlarged, partially exploded view, of a prior art holder/activator used therewith.

FIG. 2 is a top, right perspective view of a container and container holder used in a spraying device in accordance with a first embodiment of the invention.

FIG. 3 is a partial cross-sectional view of the container and container holder of FIG. 2 taken along lines 3-3 of FIG. 2.

FIG. 4 is a partial detailed view of the container and attached retainer of the container of FIG. 2.

FIG. 5 is a top view of the container holder of FIG. 2.

FIG. 6 is a cross-sectional view of the container holder of FIG. 5 taken along lines 6-6 of FIG. 5.

FIG. 7 is a perspective view of the bottom wall and triggering apparatus of the container holder of FIG. 2.

FIG. 8 is a top, left perspective view of a container and container holder used in a spraying device in accordance with a second embodiment of the invention.

FIG. 9 is a top, left perspective exploded view of the container, retainer, and the container holder of the spraying device of FIG. 8.

FIG. 9B is a bottom, left, rear perspective view of the container with the retainer of the spraying device of FIG. 8.

FIG. 10 is a right elevational view of the spraying device of FIG. 8.

FIG. 11 is a cross-sectional view of the spraying device of FIG. 8 taken along lines 11-11 of FIG. 10.

FIG. 12 is a cross-sectional view of the spraying device of FIG. 8 taken along lines 12-12 of FIG. 11.

FIG. 13 is a partial cross-sectional view of the spraying device of FIG. 8 taken along lines 13-13 of FIG. 11.

FIG. 14 is a top, left perspective view of a clip for mounting a fluid delivery device in accordance with one embodiment of the invention.

FIG. 15 is a front elevational view of the clip of FIG. 14.

FIG. 16 is a right side elevational view of the clip of FIG. 14.

FIG. 17 is a cross-sectional view of the clip of FIG. 14 taken along line 17-17 of FIG. 15.

Like reference numerals will be used to refer to like parts from Figure to Figure in the following description of the drawings.

### DETAILED DESCRIPTION OF THE INVENTION

The invention provides a device for spraying an inner surface of a toilet bowl with a chemical. Various embodiments of the invention will now be described with reference to the Figures. The embodiments are shown and described for the purposes of illustration and are not intended to limit the invention in any way.

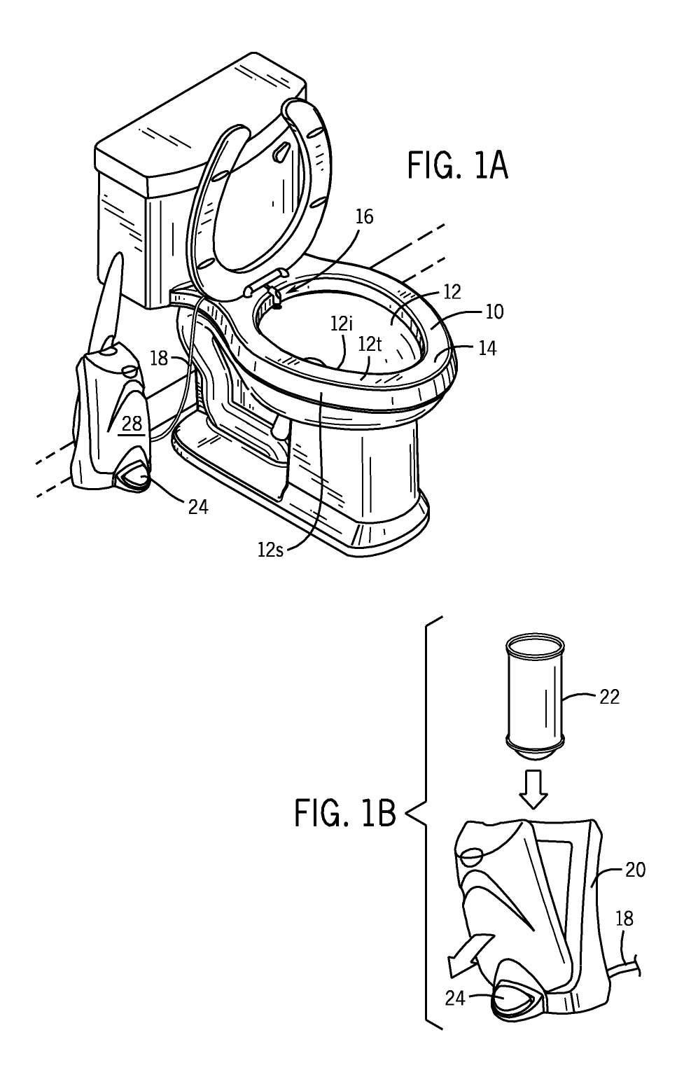

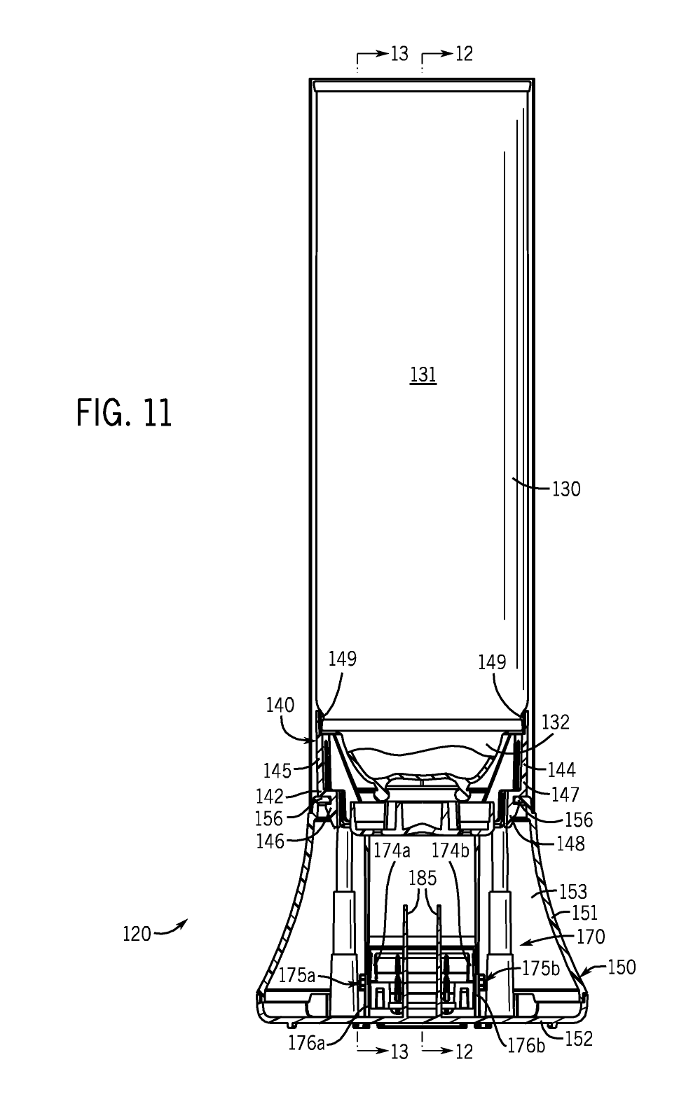

FIGS. 1A and 1B show a prior art toilet 10, per FIGS. 11A-D of U.S. Pat. No. 7,603,726. Toilet 10 has a bowl 12 with a top rim 14. A spray nozzle 16 is hooked over the rim and fed a cleaner by a fluid conduit 18. The conduit 18 links to a holder 20 to which is mounted an aerosol container 22. Pressing down on a foot pedal 24 causes spraying of cleaner along the toilet bowl sides. This is a non-automated system that sprays for as long as the pedal is depressed. The fluid can also be supplied from the container 22 to the fluid sprayer by different types of powered or manual pumps.

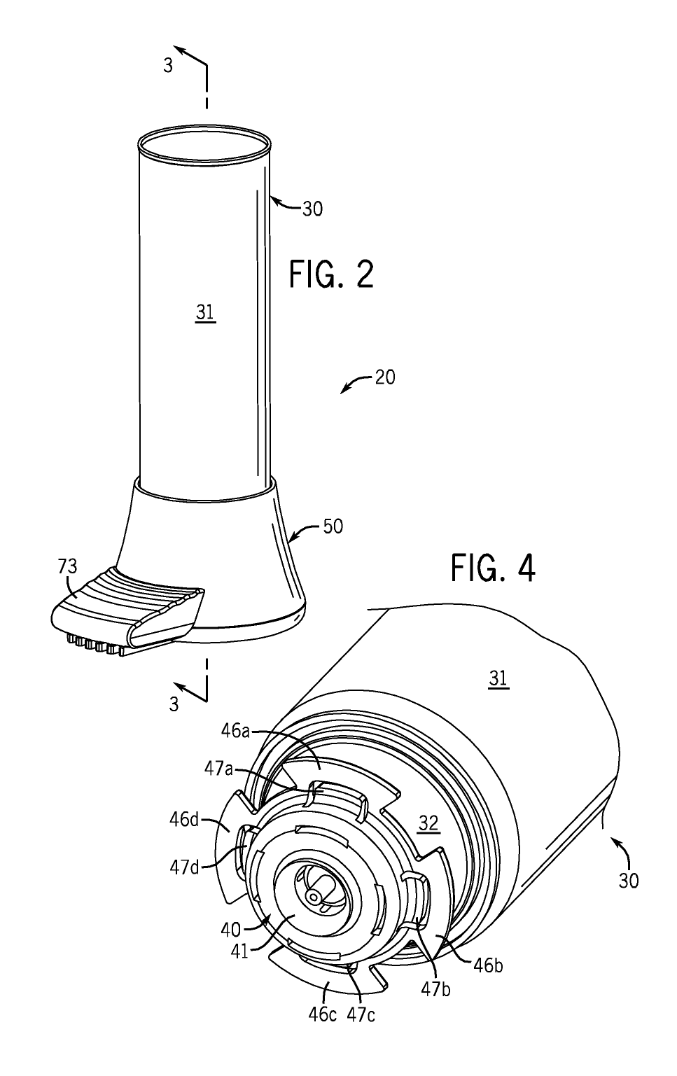

Turning now to FIGS. 2-7, there is shown a device 20 in accordance with a first embodiment of the invention for delivering fluid to a conduit, such as fluid conduit 18 in FIG. 1A. The device 20 includes an aerosol container 30 having a cylindrical outer can wall 31 and a dome 32 with a valve cup rim 33. The container 30 has a pedestal 35 with a groove 36, and a valve stem 37 that releases the contents of the container 30 when axially depressed toward the container 30.

The device 20 also includes a retainer 40 which may be formed from a polymeric material such as polyethylene or polypropylene. The retainer 40 has a central annular wall 41 with an inwardly directed rib 42. The retainer 40 also has a bottom wall 43 and a side wall 44 that define a well 45 of the retainer 40. Extending outward from the side wall 44 are four fins 46a, 46b, 46c, 46d. Flexing tabs 47a, 47b, 47c, 47d are provided near the base of the fins 46a, 46b, 46c, 46d. The retainer 40 is attached to the container 30 by engagement of the rib 42 in the groove 36 of the pedestal 35 of the container 30. A friction ring 49 contacts the valve cup rim 33 of the container 30 and the central annular wall 41 of the retainer 40 to prevent rotation of the retainer 40 with respect to the container 30.

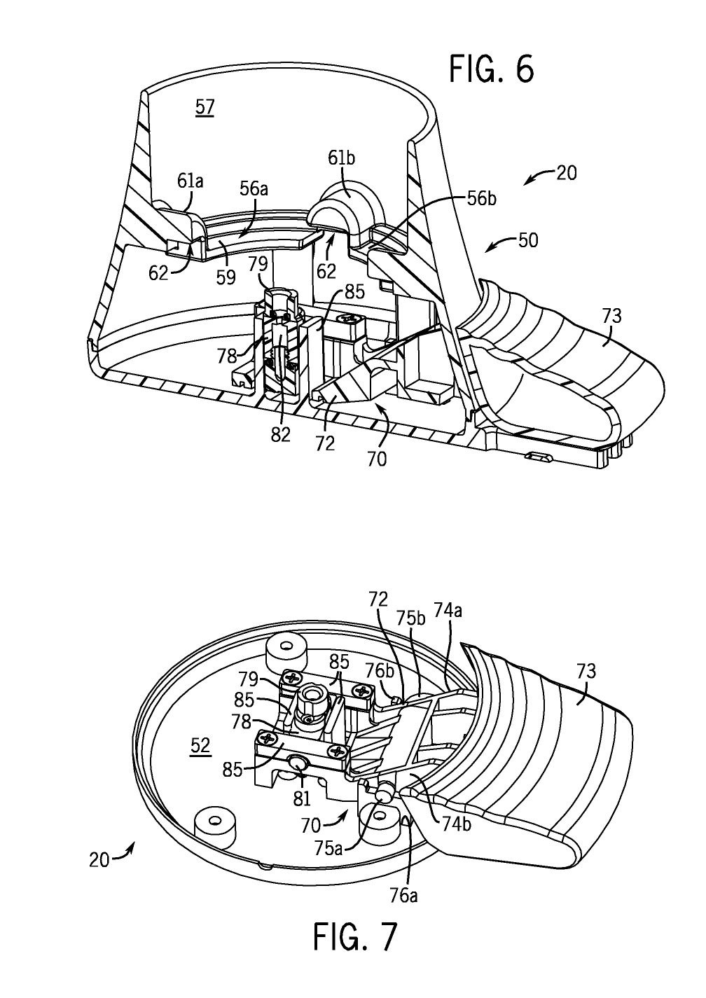

The device 20 also includes a container holder 50 having a circular side wall 51 and a bottom wall 52 that define an interior space 53 of the container holder 50. The container holder 50 has an upward opening 54. The container holder 50 includes generally horizontal spaced apart arcuate flanges 56a, 56b, 56c, 56d that extend inward from an inner wall 57 of the container holder 50. At the left end of each of the flanges 56a, 56b, 56c, 56d is a stop wall 58 (see FIG. 6) upwardly extending from a top surface 59 of each of the flanges 56a, 56b, 56c, 56d. The upper end of each stop wall 58 is connected to one of four projections 61a, 61b, 61c, 61d, which are generally in the shape of a half disk. Other shapes for the projections 61a, 61b, 61c, 61d are also suitable such as rectangular. The bottom surface 62 of each of the projections 61a, 61b, 61c, 61d is spaced upwardly from the plane in which the top surface 59 of each of the flanges 56a, 56b, 56c, 56d is located.

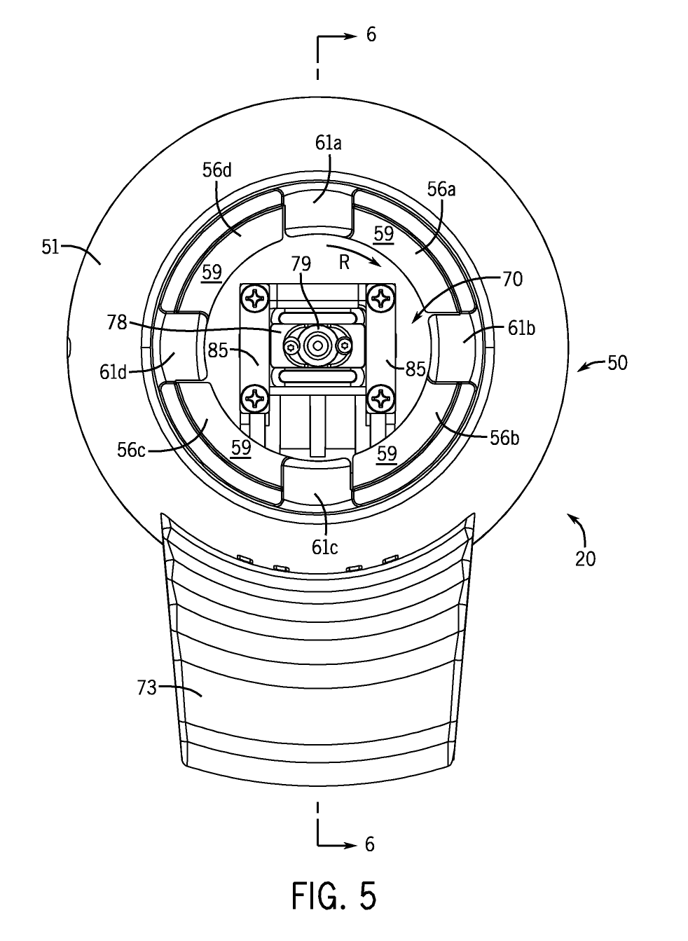

The container 30 is installed in the container holder 50 as follows. The container 30 is held over the opening 54 of the container holder 50 with the retainer 40 facing the opening 54. The fins 46a, 46b, 46c, 46d of the retainer 40 are aligned over the flanges 56a, 56b, 56c, 56d such that each of the fins 46a, 46b, 46c, 46d can pass between adjacent pairs of the projections 61a, 61b, 61c, 61d. The sloped top surface of each of the projections 61a, 61b, 61c, 61d allows for self-alignment of the fins 46a, 46b, 46c, 46d of the retainer 40 over the flanges 56a, 56b, 56c, 56d as the container 30 is moved toward the container holder 50. When each of the fins 46a, 46b, 46c, 46d contacts the top surface 59 of the flanges 56a, 56b, 56c, 56d, movement of the container 30 toward the bottom wall 52 of the container holder 50 stops. The user can then rotate the container 30 in direction R (see FIG. 5) so that a right side portion of each of the fins 46a, 46b, 46c, 46d is positioned under one of the projections 61a, 61b, 61c, 61d. Further rotation of the container 30 in direction R will cause the right side portion of each of the fins 46a, 46b, 46c, 46d to contact a stop wall 58 of each of the flanges 56a, 56b, 56c, 56d. The container 30 is then locked in place in the container holder 50. It can be appreciated that the stop walls 58 and the projections 61a, 61b, 61c, 61d can be positioned on an opposite end of each of the flanges 56a, 56b, 56c, 56d such that installation occurs with rotation in a direction opposite to direction R.

The device 20 also includes a triggering apparatus 70 for moving the valve stem 37 to an open position in the fluid exits the container 30, travels through the fluid conduit 18, moves through the fluid sprayer 16 and is sprayed on the wall of the toilet bowl 16. The triggering apparatus 70 includes a pivoting lever 72 that terminates at one end in a foot pedal 73 which is located outside the container holder 50. The lever 72 has outer support walls 74a, 74b with pivot pins 75a, 75b that rotate on walls 76a, 76b. The triggering apparatus 70 includes a manifold 78 having an inlet port 79 and an outlet port 81 that are in fluid communication with a chamber 82 of the manifold 78. The manifold 78 is pivotably mounted between support walls 85.

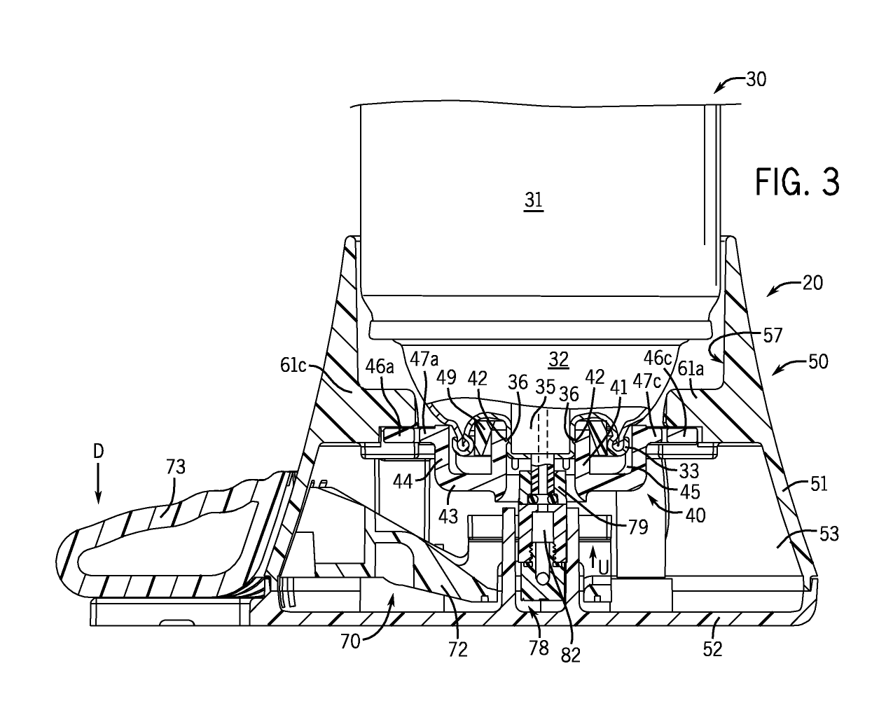

Looking now at FIG. 3, the triggering apparatus 70 moves the valve stem 37 to an open position as follows. A user presses on the foot pedal 73 in direction D and this causes the manifold 78 to move up in direction U as the lever 72 pivots on pivot pins 75a, 75b. The inlet port 79 of the manifold 78 presses in direction U on the valve stem 37 which then moves axially upward in direction U thereby releasing the fluid contents of the container 30 into the chamber 82 of the manifold 78 due to the action of a propellant in the container 30. The fluid then moves out of the outlet port 81 of the manifold 78 and into the fluid conduit 18 which feeds a spray nozzle 16 hooked over the rim 14. The nozzle 16 sprays a chemical laterally around a perimeter of a nozzle 16. As a result, full coverage of the chemical around the inner surface of the toilet bowl is possible. During operation of the triggering apparatus 70, the retention mechanism of the fins 46a, 46b, 46c, 46d of the retainer 40 and the flanges 56a, 56b, 56c, 56d, stop walls 58 and the projections 61a, 61b, 61c, 61d of the container holder 50 prevents the container 30 from moving upward when the inlet port 79 of the manifold 78 presses in direction U on the valve stem 37. The retention mechanism provides a lock and key bayonet type connection in which only containers with the properly dimensioned fins can be used with the container holder.

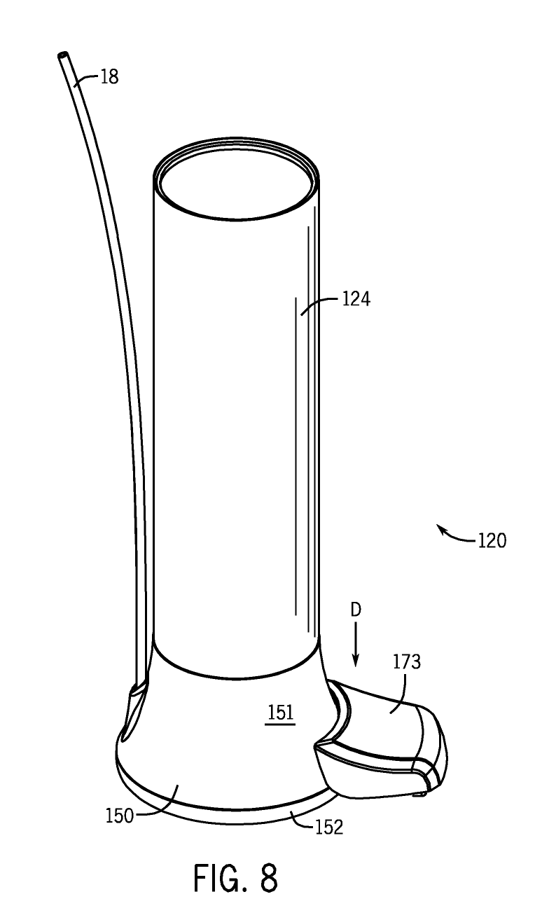

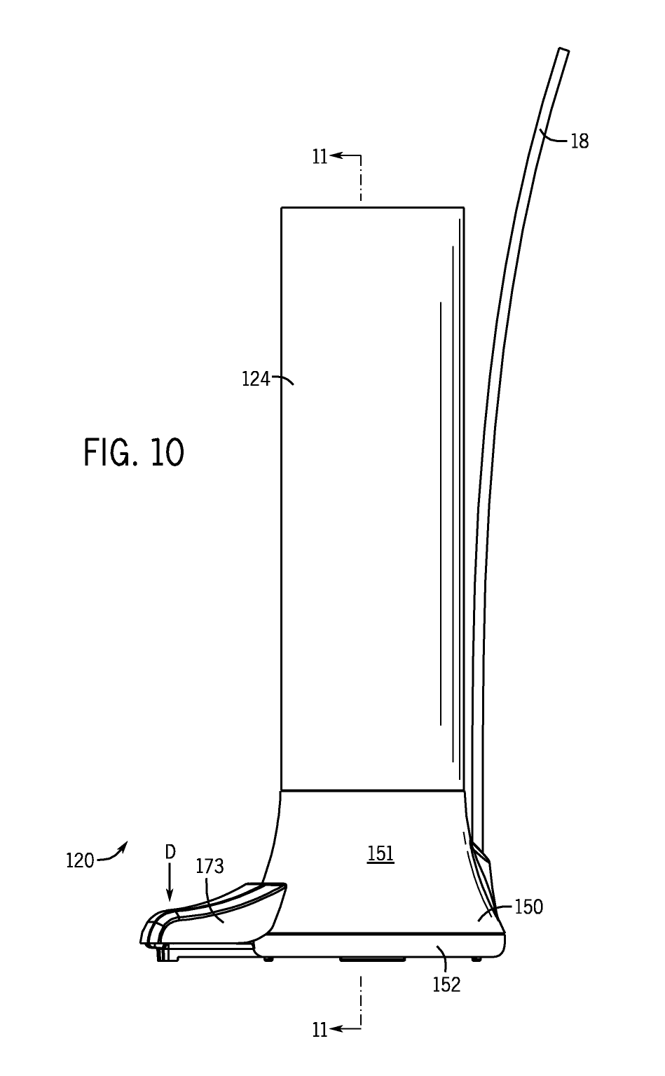

Turning now to FIGS. 8-13, there is shown a device 120 in accordance with a second embodiment of the invention for delivering fluid to a conduit, such as fluid conduit 18 in FIG. 1A. The device 120 includes a removable outer sleeve 124 covering an aerosol container 130 having a cylindrical outer can wall 131 and a dome 132 with a valve cup rim 133. The container 130 has a pedestal 135 and a valve stem 137 that releases the pressurized contents of the container 130 when axially depressed toward the container 130.

The device 120 also includes a retainer 140 which may be formed from a polymeric material such as polyethylene or polypropylene. The retainer 140 has bottom wall 143 and a side wall 144 that define a well 141 of the retainer 140. Formed in the side wall 144 are a first flexing tab 145 with an outwardly directed first ramped projection 146 and a second flexing tab 147 with an outwardly directed second ramped projection 148. The retainer 140 is attached to the container 130 by engagement of ribs 149 with a rim of the container 130.

The device 120 also includes a container holder 150 having a circular side wall 151 and a bottom wall 152 that define an interior space 153 of the container holder 150. The container holder 150 has an upward opening 154. The container holder 150 includes an inwardly directed horizontal circumferential flange 156 that extends inward from the side wall 151 of the container holder 150.

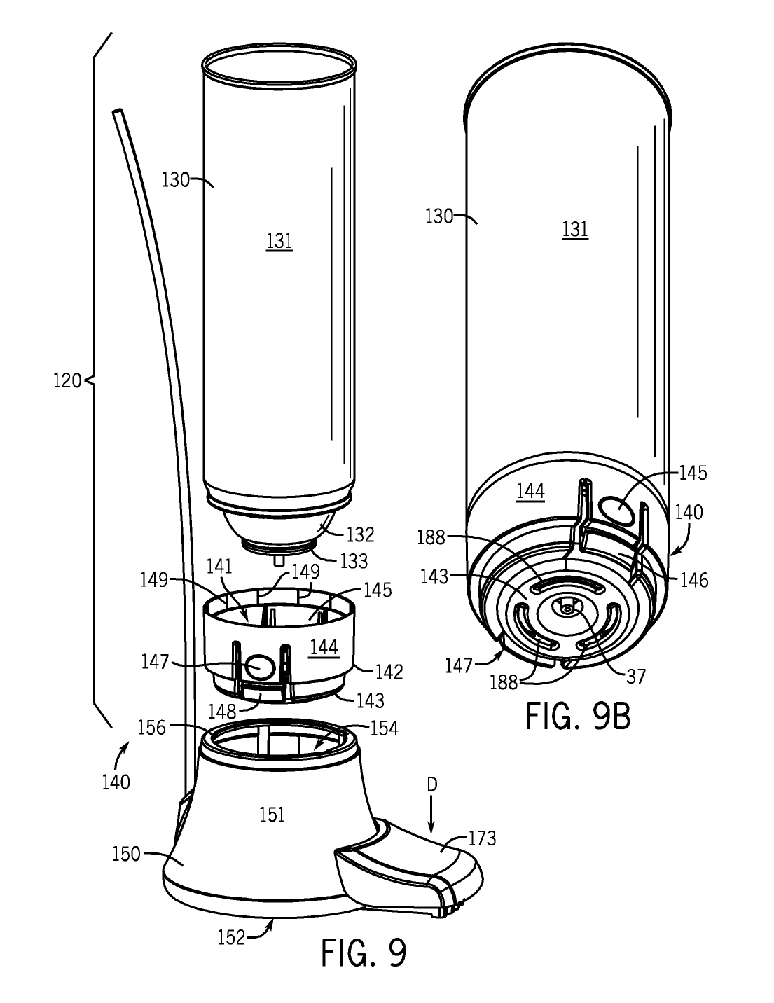

The container 130 is installed in the container holder 150 as follows. The container 130 is held over the opening 154 of the container holder 150 with the retainer 140 facing the opening 154. The container 130 is moved toward the container holder 150 until the first ramped projection 146 and the second ramped projection 148 contact the inwardly directed horizontal circumferential flange 156 of the container holder 150. Further downward movement of container 130 causes the first flexing tab 145 and the second flexing tab 147 to flex inward until the first ramped projection 146 and the second ramped projection 148 move under the inwardly directed horizontal circumferential flange 156 as shown in FIG. 11. Shoulder 142 of the retainer 140 then rests on the top of the inwardly directed horizontal circumferential flange 156 of the container holder 150. Arcuate slots 188 (see FIG. 9B) in the bottom wall 143 of the retainer 140 also receive upwardly extending locating tabs of the container holder 150. The container 130 is thereby locked in place in the container holder 150.

To remove the container 130 from the container holder 150, a user presses inward on the first flexing tab 145 and the second flexing tab 147 such that the first ramped projection 146 and the second ramped projection 148 are spaced inward from the inwardly directed horizontal circumferential flange 156 of the container holder 150. The user can then move the container 130 upward and away from the container holder 150.

The device 120 also includes a triggering apparatus 170 for moving the valve stem 137 to an open position in which the fluid exits the container 130, travels through the fluid conduit 18, moves through the fluid sprayer 16 and is sprayed on the wall of the toilet bowl 16. The triggering apparatus 170 includes a pivoting lever 172 that terminates at one end in a foot pedal 173 which is located outside the container holder 150. The lever 172 has outer support walls 174a, 174b with pivot pins 175a, 175b that rotate on walls 176a, 176b. The triggering apparatus 170 includes a manifold 178 having an inlet port 179 and an outlet port 181 that are in fluid communication with a chamber 182 of the manifold 178. The manifold 178 is pivotably mounted between support walls 185.

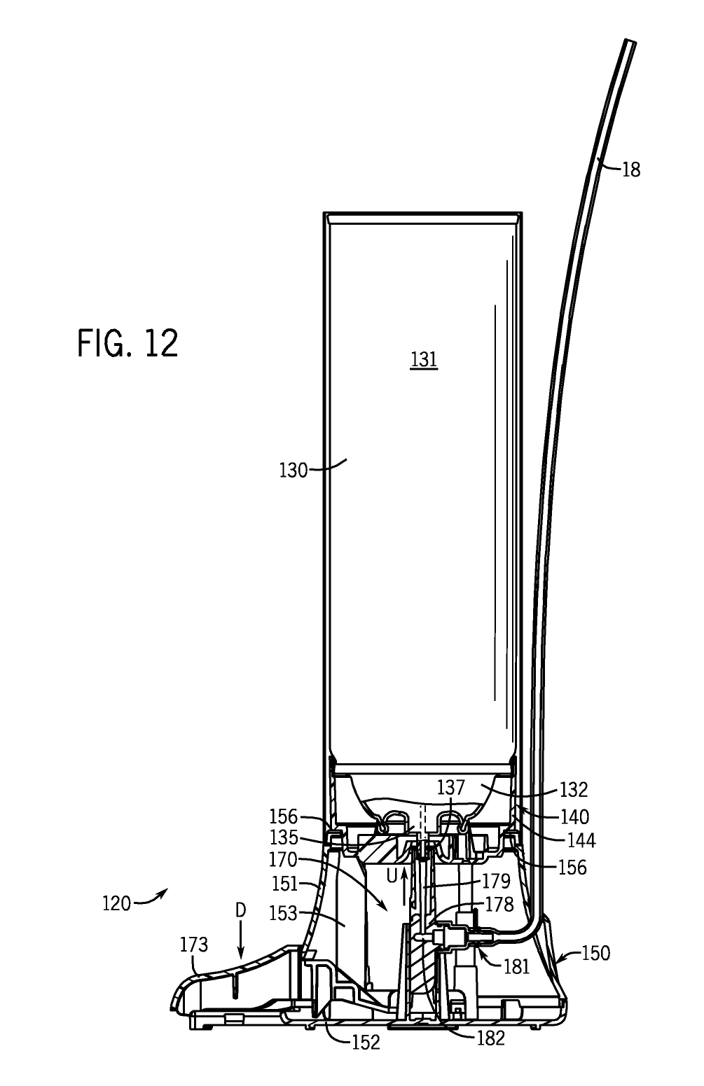

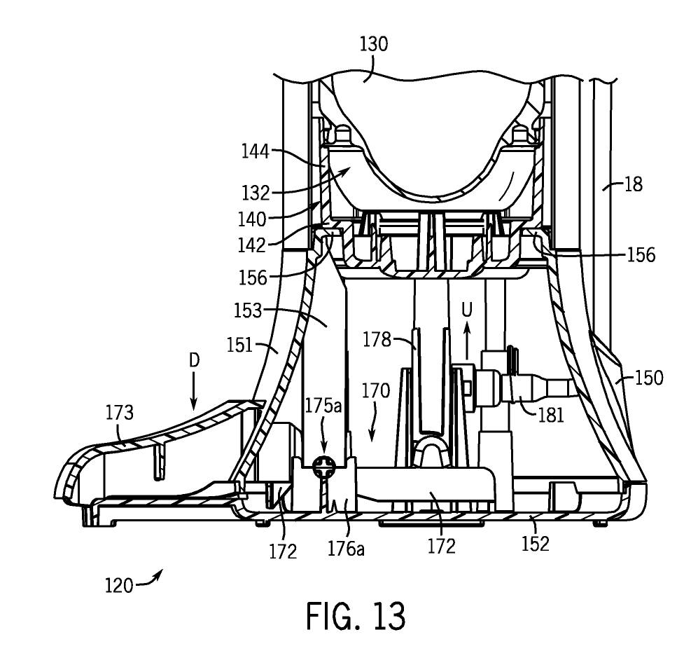

Looking now at FIGS. 12 and 13, the triggering apparatus 170 moves the valve stem 137 to an open position as follows. A user presses on the foot pedal 173 in direction D and this causes the manifold 178 to move up in direction U as the lever 172 pivots on pivot pins 175a, 175b. The inlet port 179 of the manifold 178 presses in direction U on the valve stem 137 which then moves axially upward in direction U thereby releasing the fluid contents of the container 130 into the chamber 182 of the manifold 178 due to the action of a propellant in the container 130. The fluid then moves out of the outlet port 181 of the manifold 178 and into the fluid conduit 18 which feeds a spray nozzle 16 hooked over the rim 14. The nozzle 16 sprays a chemical laterally around a perimeter of a nozzle 16. As a result, full coverage of the chemical around the inner surface of the toilet bowl is possible. During operation of the triggering apparatus 170, the retention mechanism of the first ramped projection 146 and the second ramped projection 148 of the retainer 140 and the inwardly directed horizontal circumferential flange 156 of the container holder 150 prevents the container 130 from moving upward when the inlet port 179 of the manifold 178 presses in direction U on the valve stem 137. The retention mechanism provides a lock and key connection in which only containers with a retainer 140 with the properly dimensioned side wall 144, first flexing tab 145, second flexing tab 147, first ramped projection 146, and second ramped projection 148 can be used with the container holder 150 having the circumferential flange 156.

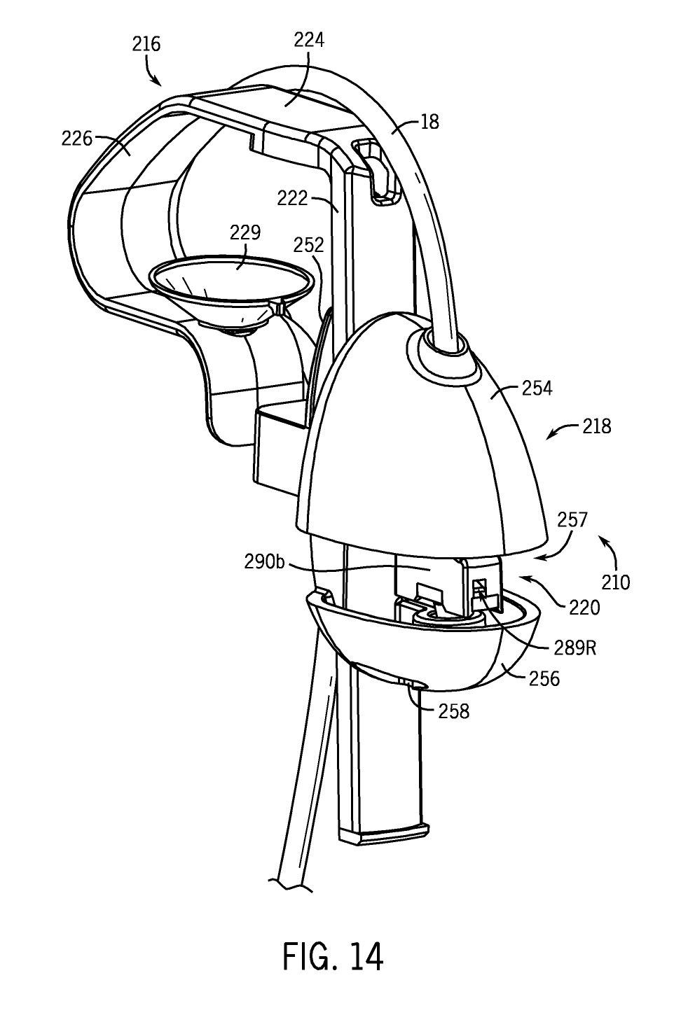

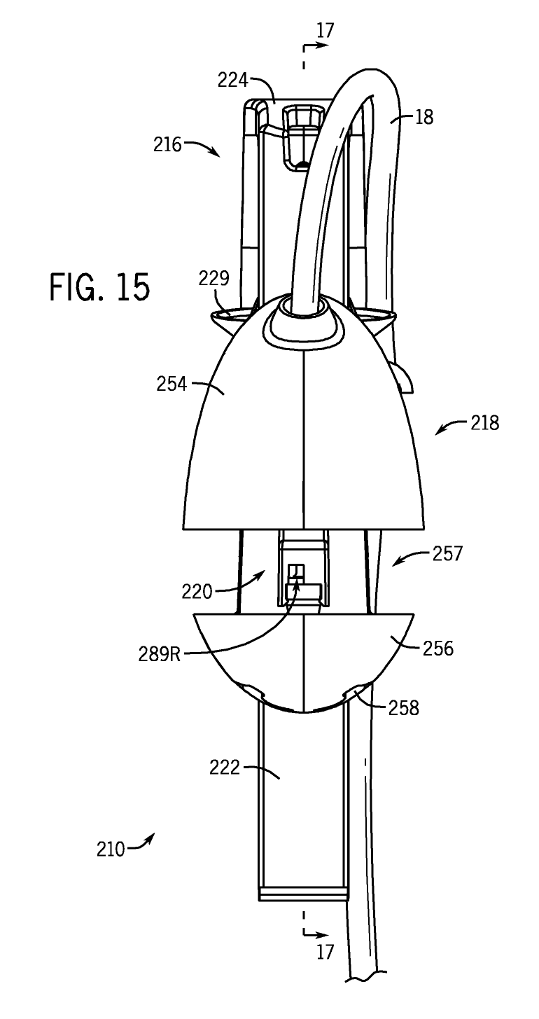

Turning now to FIGS. 14-17, there is shown an example embodiment of a clip 210 for mounting a fluid delivery device (e.g. a sprayer) to an enclosure such as a toilet bowl. The clip 210 is secured to the rim 14 of the toilet bowl 12 by an adjustable mounting mechanism 216. A base 218 is supported by the mounting mechanism 216 and supports a fluid delivery device, here a nozzle 220. A container supplies fluid via a fluid conduit 18 to the fluid delivery device 220 to be dispensed onto the inside surface of the toilet bowl in the manner of the spray nozzle 16 of FIGS. 1A-1B. The fluid can be supplied from the container to the fluid delivery device 220 in a variety of ways; for example, the fluid may be motivated by a gaseous propellant, by a manual or electric pump, a syringe, or any other suitable means. Furthermore, the execution of the fluid delivery from the container can be controlled by a variety of methods/devices, one being a timing circuit using predetermined logic to control when the fluid is dispensed.

The mounting mechanism 216 for supporting the base 218 and attaching the clip 210 to the toilet bowl 12 includes a vertical support 222 attached to a first arm 224 extending laterally from vertical support 222 and a flexing second arm 226 extending downward from the first arm 224. A clip 228 holds the fluid conduit 18 adjacent the second arm 226 as it is routed on its way to the nozzle 220 in the base 218. The support 222 is preferably molded from a polymeric material (e.g., polyethylene or polypropylene). A suction cup 229 is mounted on the inside of the second arm 226.

When the clip 210 is mounted to the toilet bowl 12, the second arm 226 is flexed outward such that the second arm 226 and the suction cup 229 contact an outer surface 12s of the toilet bowl 12, and the first arm 224 contacts a top surface 12t of the rim 14 of the toilet bowl 12, and a second side 239 of the support 222 contacts an inner surface 12i of the toilet bowl 12 as the first arm 224 and the second arm 226 hang on the rim 14. The suction force provided by the suction cup 229 on the outer surface 12s of the toilet bowl 12 keeps the second arm 226 in contact with the outer surface 12s of the toilet bowl 12.

The base 218 of the clip has a back face 252, a top front face 254, and a bottom front face 256 that form a hollow shroud around the nozzle 220. A transverse opening 257 is formed between the top front face 254 and the bottom front face 256. A drain opening 258 is provided in the bottom of the bottom front face 256 for draining away fluid that may accumulate inside the shroud. The base 218 is preferably molded from plastic (e.g., polyethylene or polypropylene).

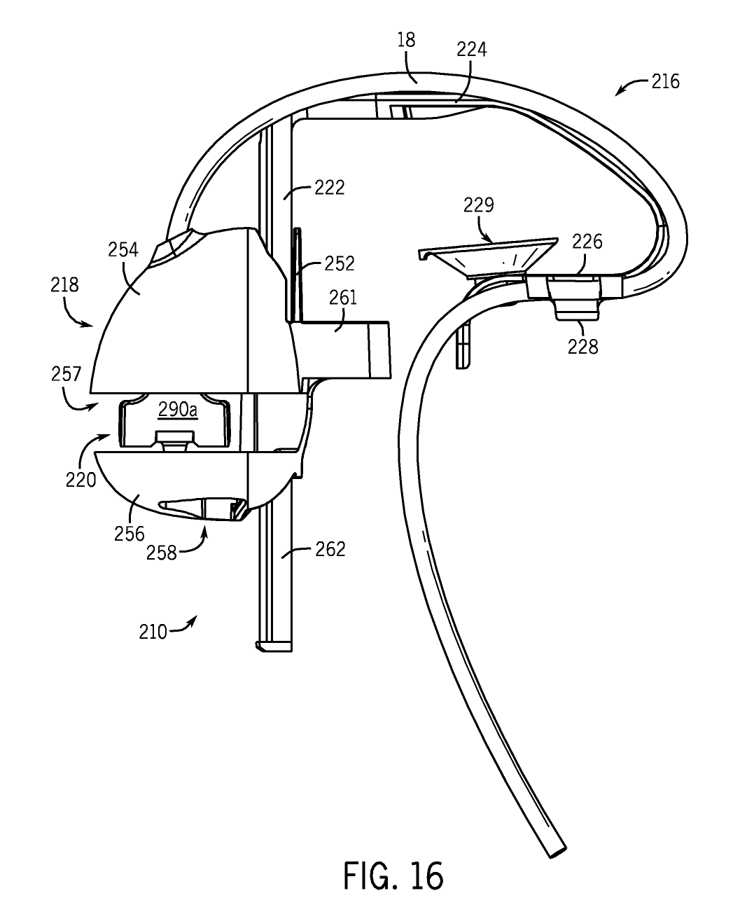

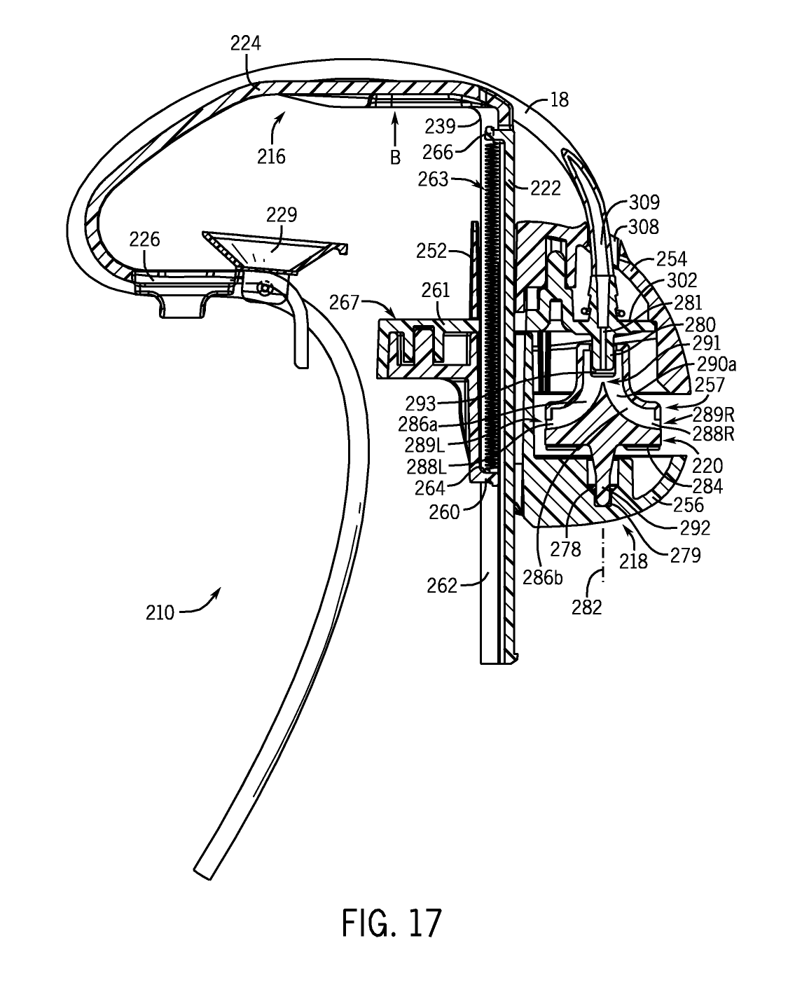

Looking at FIGS. 16 and 17, the base 218 includes a tab 260 that extends inward from the back face 252 and a plate 261 that projects outward from the back face 252. The tab 260 is dimensioned to slide within a channel 262 of the support 222. An extension spring 263 is attached to an inwardly directed mounting hook 264 of back face 252 of the base 218 and also attached to a mounting hook 266 of the support 222.

A user can apply a force in direction B (see FIG. 17) on the base 218 to move the first arm 224 away from the base 218. This creates a larger distance between the first arm 224 and the base 218 when mounting the clip 210 to the toilet bowl 12. When the clip 210 has been mounted to the toilet bowl 12, the spring 263 biases the first arm 224 toward the base 218 such that the first arm 224 grips the top rim 14 of the toilet bowl 12, and a top surface 267 of the plate 261 grips an undersurface of the toilet bowl 12.

The base 218 includes a means to attach a fluid delivery device (e.g., nozzle 220) to the base 218. In the example embodiment, the nozzle 220 is restrained laterally between a barrel 278 and a fluid inlet 280. The fluid inlet 280 and the barrel 278 are used in conjunction to restrain lateral movement of the nozzle 220, but allow the nozzle 220 to rotate about the nozzle axis 282. The tubular fluid inlet 280 defines a flow path 281, and extends downwardly from a wall 302 that is attached to the base 218. The base 218 includes a fluid supply opening 308 that defines a flow path 309. The fluid supply opening 308 is located in the top front face 254 of the base 218, and may be connected to fluid conduit 18 (see FIG. 17).

The inner flow paths of the nozzle 220 are shown in greater detail. The nozzle 220 is preferably molded from polymeric material (e.g., polyethylene and polypropylene). The nozzle 220 includes a bottom wall 284. An axial spindle 292 extends downward from the bottom wall 284. Spaced apart walls 290a, 290b, which have a generally inverted T-shape, extend upward from the bottom wall 284. A central fluid deflection peak 291 extends upward from the bottom wall 284 between the walls 290a, 290b. Passageways 286a, 286b are defined by the walls 290a, 290b and the peak 291, and the passageways 286a, 286b extend upwards from the bottom wall 284. The contour of the walls 290a,290b may vary depending on the desired rotational speed of the nozzle 220, the pressure of the fluid, the flow rate of the fluid, and the like.

The nozzle 220 is restrained laterally by inserting a spindle 292 into a recess 279 in the barrel 278 and by inserting the end of the fluid inlet 280 in depression 293. The nozzle 220 is free to rotate about the nozzle axis 282, but is restrained from lateral movement.

In operation, fluid is moved from a container through a fluid conduit (see, for example, the container 22 and the conduit 18 of FIG. 1A) and into the fluid supply opening 308. The fluid flows through the flow paths 309 and 281, and out of the fluid inlet 280. (The diameter of the exit orifice of the fluid inlet 280 can dictate the pressure which helps to dictate the spin rate and the distance of fluid travel off the nozzle 220.) Fluid flows onto the top of the fluid deflection peak 291 and down the forked passageways 286 where it is directed radially outward by channels 288L, 288R. As the fluid exits the channels 288L, 288R, the fluid path is altered by the angled inner surfaces flanking the channels 288L, 288R. The reaction causes the nozzle 220 to rotate. As a result, the fluid is expelled radially outward from fluid outlets 289L, 289R of the nozzle 220, through the transverse opening 257, and onto the inside surface of the enclosure such as the inner wall surface of a toilet bowl.

Various cleaning and/or deodorizing chemicals are suitable for use with a toilet bowl cleaning device according to the invention. For example, mildly acidic and near neutral pH antimicrobial compositions such as those described in U.S. Pat. Nos. 6,471,974 and 6,162,371 can be advantageous when used with a toilet bowl cleaning device according to the invention. Alkaline antimicrobial toilet bowl cleaning formulations such as those described in U.S. Pat. No. 6,425,406 can also be advantageous. Acidic compositions such as those described in U.S. Pat. No. 6,812,196 may also be suitable. When using a steel container and acidic compositions, a steel container with a plastic liner or a bladder with a surrounding propellant may be desirable to minimize acidic corrosion of the steel container. Aluminum containers may also be an option for acidic compositions. The above chemicals are non-limiting illustrative examples of cleaning and/or deodorizing chemicals suitable for use with a toilet bowl cleaning device according to the invention. Other example suitable chemicals include, for example, enzymes, chelating agents, corrosives and amino acids.

Although the present invention has been described in detail with reference to certain embodiments, one skilled in the art will appreciate that the present invention can be practiced by other than the described embodiments, which have been presented for purposes of illustration and not of limitation. Therefore, the scope of the invention should not be limited to the description of the embodiments contained herein.

### INDUSTRIAL APPLICABILITY

The present invention provides a toilet bowl cleaning device for spraying an inner surface of the toilet bowl, and/or the toilet water, and/or under the toilet rim with a cleaning and/or deodorizing chemical.

All documents cited in the Detailed Description of the Invention are, in relevant part, incorporated herein by reference; the citation of any document is not to be construed as an admission that it is prior art with respect to the present invention.

What is claimed is:

1. A device for spraying an inner surface of a wall of an enclosure with a fluid, the device comprising:
a container for the fluid;
a container holder;
a fluid conduit in fluid communication with the container and a fluid sprayer;
a clip attaching the fluid sprayer near the inner surface of the wall of the enclosure; and
a retention mechanism retaining the container in the container holder, the retention mechanism comprising:
a retainer connected to the container adjacent an end of the container.

2. The device of claim 1 wherein the retention mechanism further comprises:
at least one inwardly directed flange on a wall of the holder, the wall defining the opening of the holder;
wherein the retainer is dimensioned to engage the container.

3. The device of claim 2 wherein the retainer has a plurality of flexing tabs.

4. The device of claim 3 wherein the at least one flange is a circumferential flange and the plurality of flexing tabs engage the circumferential flange.

5. The device of claim 4 wherein the plurality of flexing tabs include a pair of flexing tabs that are on opposite ends of a diameter of the retainer, each of the pair of flexing tabs having an outwardly directed projection with a ramped outer surface, the outwardly directed projections being dimensioned to releasably engage the circumferential flange.

6. The device of claim 1 wherein the retention mechanism further comprises:
a plurality of flanges on an inner wall of the holder;
a stop connected to each flange, each stop extending laterally from its associated flange; and
a projection spaced apart from each flange and adjacent to the stop associated with each flange, each projection connected to the inner wall of the holder and being inwardly directed from the inner wall of the holder;
wherein the retainer is dimensioned to engage the container, the retainer having a plurality of fins extending outward from a central region of the retainer, each fin being dimensioned to pass between adjacent projections when the retainer is moved toward the flanges, each fin being dimensioned to enter a space adjacent one of the projections and contact one of the stops when the container is rotated after the fins have passed the projections.

7. The device of claim 1 wherein the container is an aerosol can having a valve stem and the device further comprises:
a triggering apparatus for moving the valve stem to an open position wherein the fluid exits the container, travels through the fluid conduit, moves through the fluid sprayer and is sprayed on the wall of the enclosure.

8. The device of claim 7 wherein:
the triggering apparatus comprises a foot actuated lever linked to the valve stem.

9. The device of claim 8 wherein:
the holder receives the container in an inverted position of the container, and
the retention mechanism prevents movement of the container when the foot actuated lever is pressed.

10. A retention mechanism for a dispenser including a container and a holder for receiving the container in an opening of the holder, the retention mechanism comprising:
at least one flange on a wall of the holder; and
a retainer dimensioned to engage the container, the retainer being connected to the container adjacent an end of the container.

11. The retention mechanism of claim 10 wherein the retainer includes a plurality of flexing tabs.

12. The retention mechanism of claim 10 wherein the at least one flange of the holder is inwardly directed on the wall of the holder.

13. The retention mechanism of claim 10 wherein the at least one flange is a circumferential flange and the retainer has a pair of flexing tabs that are on opposite ends of a diameter of the retainer, each of the pair of flexing tabs having an outwardly directed projection with a ramped outer surface, the outwardly directed projections being dimensioned to releasably engage the circumferential flange.

14. The retention mechanism of claim 10, further comprising:
a stop connected to each flange, each stop extending laterally from its associated flange; and
a projection spaced apart from each flange and adjacent to the stop associated with each flange, each projection connected to an inner wall of the holder and being inwardly directed from the inner wall of the holder;
wherein the retainer is dimensioned to engage the container, the retainer having a plurality of fins extending outward from a central region of the retainer, each fin being dimensioned to pass between adjacent projections when the retainer is moved toward the flanges, each fin being dimensioned to enter a space adjacent one of the projections and contact one of the stops when the container is rotated after the fins have passed the projections.

15. The retention mechanism of claim 14 wherein each projection is connected to the adjacent stop associated with each flange.

16. A refill for a sprayer system including a container holder and a fluid conduit in fluid communication with an outlet of the container holder and a fluid sprayer, the refill comprising:
a container; and
a retainer connected to the container, the retainer having at least one flexing tab in a side wall of the retainer.

17. The refill of claim 16 wherein the retainer has a pair of flexing tabs in the side wall of the retainer on opposite ends of a diameter of the retainer, the pair of flexing tabs each having an outwardly directed projection with a ramped outer surface, the pair of flexing tabs each being dimensioned to releasably engage a circumferential flange of the container holder.

18. The refill of claim 17 wherein the ramped outer surface of the projection of each flexing tab is configured to inwardly flex the flexing tabs when the container is pushed into the container holder until the projections move under the circumferential flange.

19. The refill of claim 16 wherein the retainer has a plurality of fins extending outward from a central region of the retainer, each fin having a flexing tab near a base of the fin, each fin being dimensioned to engage a flange on an inner wall of the container holder, each fin being dimensioned to pass between adjacent projections connected to the inner wall of the container holder when the retainer is moved into an opening of the container holder, each fin being dimensioned to enter a space adjacent one of the projections and contact a stop of the container holder when the container is rotated after the fins have passed the projections and have engaged one of the flanges.

20. The refill of claim 16 wherein the container is an aerosol can having a valve stem.
